(19) United States
(12) Patent Application Publication
(10) Pub. No.: US 2026/0316725 A1
(43) Pub. Date: Oct. 15, 2026

(54) Towbar-Actuated Braking Mechanism with Both Parking and Failsafe Braking Functionalities

(71) Applicant: AVRO Ground Support Equipment Inc., Oxbow (CA)

(72) Inventor: Justin Waldner, Minnedosa (CA)

(21) Appl. No.: 19/632,586

(22) Filed: Mar. 30, 2026

Related U.S. Application Data
(60) Provisional application No. 63/787,317, filed on Apr. 11, 2025.

(51) Int. Cl. B60T 1/04; B60T 7/20; B60T 11/04

(52) U.S. Cl. CPC B60T 1/04; B60T 7/20; B60T 11/04

(57) ABSTRACT

A towable vehicle having a towbar-actuated braking mechanism operable on at least one braked wheel to inhibits rolling motion of the vehicle. The towbar is pivotable between an upright parking position, a generally horizontal towing position and a dropped position of declined orientation from the towing position. A motion converter is connected between the towbar and a brake assembly that resides proximate the braked wheel(s) and is movable between braking and non-braking positions of engaged and disengaged relationship to the braked wheel. The motion converter drives motion of the brake assembly into the braking position both in movement of the towbar from the towing position to the parking position and in movement of the towbar from the towing position to the dropped position, thereby imparting both a parking brake function in the parking position and a failsafe braking function in the dropped position.

### CROSS-REFERENCE TO RELATED APPLICATIONS

This application claims benefit under 35 U.S.C. 119(e) of U.S. Provisional Application No. 63/787,317, filed Apr. 11, 2025, the entirety of which is incorporated herein by reference.

### FIELD OF THE INVENTION

The present invention relates generally to towed vehicles, and more particularly to towbar-actuated braking mechanisms for such vehicles that impart a parking brake action thereon in a raised position of the towable vehicle's towbar.

### BACKGROUND

Towed vehicles commonly employed as ground support equipment (GSE) for serving aircraft in the context of airport operations often employ towbar-actuated brakes of the type referenced in the preceding paragraph, examples of which include baggage carts, mail carts, dollies and supply trailers. Examples of such towbar-actuated braking mechanisms can be seen, for example, in U.S. Pat. Nos. 4,949,986, 6,508,479, 6,637,764, 9,744,955, and 10829096, and US Patent Application Publications 20040238290 and 2006/0186625. Generally speaking, these braking mechanisms are typically configured so that when a pivotally supported towbar of the towed vehicle is decoupled from a towing vehicle, raising of the decoupled towbar of the towed vehicle into an upright orientation acts to engage the two wheels on a shared axle of the towed vehicle with respective brakes that physically engage with the tires of those two wheels at rear sides thereof opposite the towbar. When the towbar is lowered back down into a suitable towing position reaching forwardly from the front end of the towed vehicle for recoupling thereof to a towing vehicle, this pivotal lowering of the towbar serves to withdraw the brakes from the tires. This way, any time the towed vehicle is uncoupled from a towing vehicle, the user can manually lift the towbar to apply the brakes as an effective parking brake.

That said, Applicant has realized that there is room for improvement in such towbar-actuated braking mechanisms, which could be exploited for further safety reasons beyond the aforementioned parking brake function, and which improvement is the subject of the present application.

### SUMMARY OF THE INVENTION

According to a first aspect of the invention, there is provided a towable vehicle having a towbar-actuated braking mechanism, said towable implement comprising:
a vehicle body for carriage of a load thereon and having front and rear ends of opposing relationship to one another in a longitudinal direction;
a plurality ground wheels by which the vehicle body is supported for rolling movement thereof over the ground, and among which there is included at least one braked ground whel on which a braking action is impartible to inhibit rolling movement of the towable vehicle;
a towbar coupled to the vehicle body and usable for towing thereof when coupled to a separate towing vehicle, said towbar being pivotally supported for upward and downward movement of a distal end of said towbar about a towbar pivot axis that is situated nearer to an opposing proximal end of said towbar than to said distal end, said towbar being pivotable about said pivot axis between a parking position, a towing position and a dropped position, among which the parking position has a most upright orientation placing the distal end at an elevation above the towbar pivot axis, the dropped position has a most declined orientation placing the distal end at a lower elevation nearer to ground than in the parking and towing positions, and the towing position resides intermediately of the parking and dropped positions and has a most horizontal orientation with the distal end at an intermediate elevation between those occupied in the parking and dropped positions;
a brake assembly residing proximate the at least on braked and movable relative thereto between braking and non-braking positions of engaged and disengaged relation to said at least one braked ground wheel; and
a motion converter connected between said towbar and said brake assembly to drive motion of the brake assembly in responsive relation to pivotal movement of the towbar about the towbar pivot axis, and specifically configured to drive motion of the brake assembly into said engaged relation with said at least one ground wheel both in movement of the towbar from the towing position to the parking position and in movement of the towbar from the towing position to the dropped position, whereby the at least one braked ground wheel is engaged by the brake assembly in both the parking and dropped positions of the towbar to thereby impart both a parking brake function in the parking position and a failsafe braking function in the dropped position.

The at least one braked ground wheel preferably comprises a pair of braked ground wheels.

According to a second aspect of the invention, there is provided a towable vehicle with a towbar-actuated braking mechanism, said towable implement comprising:
a vehicle body for carriage of a load thereon and having front and rear ends of opposing relationship to one another in a longitudinal direction;
a plurality ground wheels by which the vehicle body is supported for rolling movement thereof over the ground, and among which there is included at least one braked ground wheel on which a braking action is impartible to inhibit rolling movement of the towable vehicle;
a towbar coupled to the vehicle body and usable for towing thereof when coupled to a separate towing vehicle, said towbar being pivotally supported for upward and downward movement of a distal end of said towbar about a towbar pivot axis that is situated nearer to a proximal end of said towbar than to said distal end, said towbar being pivotable about said pivot axis between at least a parking position and a towing position, among which the parking position has a more upright orientation placing the distal end at an elevation above the towbar pivot axis, and the towing position spans further forwardly from the pivot axis than said parking position;
a brake assembly residing proximate the at least one braked ground wheel and movable relative thereto braking and non-braking positions of engaged and disengaged relation to said at least one braked ground wheel; and
a motion converter connected between said towbar and said brake assembly to drive motion of the brake assembly in responsive relation to pivotal movement of the towbar about the towbar pivot axis, and specifically configured to drive motion of the brake assembly into said engaged relation with said at least one braked ground wheel in movement of the towbar from the towing position to the parking position so as to thereby engage the at least one braked ground wheel and impart a parking brake function thereto in the parking position;
wherein the brake assembly comprises, for each braked ground wheel, a respective tire brake for engaged contact with a tire of said braked ground wheel, said respective tire brake comprising an undulating shape profile at a tire-facing side thereof.

According to a third aspect of the invention, there is provided a tire brake for use in a towbar-actuated braking mechanism, said tire brake comprising an undulating shape profile at a tire-facing side thereof.

### BRIEF DESCRIPTION OF THE DRAWINGS

Preferred embodiments of the invention will now be described in conjunction with the accompanying drawings in which:

FIG. 1 is a top front perspective view of a towable baggage cart featuring a steerable front axle and an inventive towbar-actuated braking mechanism installed thereon, which steerable baggage cart is merely one non-limiting example of a towed vehicle on which the inventive braking mechanism may be implemented.

FIG. 2 is another top front perspective view of the baggage cart of FIG. 1, but shown only in part, in particular closeup the towbar and associated towbar-actuated braking mechanism of said baggage cart.

FIG. 3 is an isolated top front left perspective view of the steerable front axle assembly of the baggage cart, and the associated towbar and towbar-actuated braking mechanism installed thereon, with the towbar in a horizontal towing position thereof in which no braking action is imparted on the wheels of the steerable front axle assembly.

FIG. 4 is an isolated top plan view of the same componentry illustrated in FIG. 3, except for an omitted cross-member of a supportive subframe, removed for illustrative purpose.

FIG. 5 is an isolated side elevational view of the same componentry illustrated in FIGS. 3 and 4, as cross-sectioned along line A-A of FIG. 4.

FIG. 6 is an isolated side elevational view of the same componentry illustrated in FIGS. 3 to 5, in the same cross-sectional plane as FIG. 5, but with the towbar lowered to a dropped position of downwardly tilted relation to the towing position, which dropped position of the towbar engages the braking mechanism with the wheels of the steerable front axle for novel failsafe braking purposes.

FIG. 7 is an isolated side elevational view of the same componentry illustrated in FIGS. 3 to 6, in the same cross-sectional plane as FIGS. 5 and 6, but with the towbar raised into an upstanding parking position that also acts to impart a braking action on the wheels of the steerable front axle, for parking brake purposes.

FIG. 8 is a substantially isolated perspective view of a tire brake from the towbar-actuated braking mechanism of the preceding Figures.

FIG. 8A is a side elevational view of the tire brake of FIG. 8.

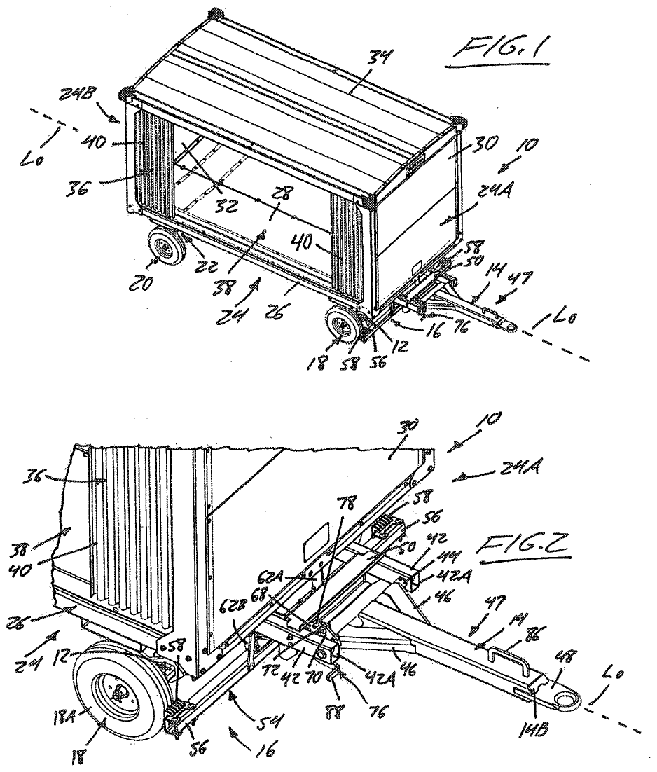

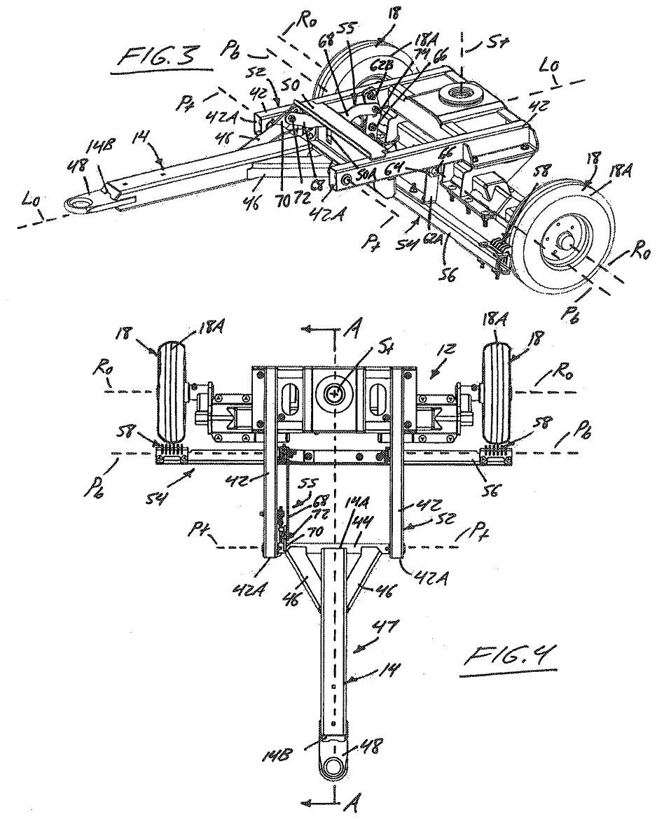

### DETAILED DESCRIPTION

Described herein below with reference to the above summarized drawings is an inventive towbar-actuated braking mechanism usable on a baggage cart, or on any other variety of towable vehicle equipped with a pivotable towbar. The inventive braking mechanism differs most notably from the aforementioned prior art in that it is operable to automatically impart a braking action on the baggage cart not only in an intentionally raised parking position of the towbar, for parking brake purposes whenever the baggage cart is intentionally parked in uncoupled relationship to a towing vehicle, but also anytime the towbar drops down from its usable towing position toward the ground in the absence of either a coupled connection to a towing vehicle or proper securement of the towbar in the raised parking position. This way, any unintentional dropping of the towbar, whether by equipment failure or user error in either attempted coupling of the baggage cart to a towing vehicle or attempted securement of the towbar in the raised parking position, will automatically apply impart a failsafe braking action on the baggage cart to prevent unintended runaway travel thereof. This novel failsafe braking functionality provides greater safety (accident protection) for the baggage cart, its users and other occupants of its operating environment (airport personnel, aircraft, other GSE, etc.).

Illustrated as merely one non-limiting example of an operating context for the inventive towbar-actuated brake mechanism of the present invention, the drawings show a towable baggage cart 10 with a steerable front axle assembly 12 that hosts both a pivotable towbar 14 of the baggage cart 10 and the associated towbar-actuated braking mechanism 16 that is the subject of the present invention (also referred to herein simply as the braking mechanism 16, for brevity). The baggage cart 10 is cooperatively supported on the ground by a pair of steerable front ground wheels 18 hosted by the steerable front axle assembly 12, and a pair of non-steerable rear ground wheels 20 instead installed on a fixed (non-steerable) rear axle 22. Supported atop the two axles is a vehicle body 24 of the baggage cart 10, whose purpose is to host the intended load of the vehicle, which in this case would be air-traveller baggage to be loaded or unloaded onto or from an aircraft. In this baggage cart context, the vehicle body features a frame 26, a floor deck 28 installed atop the frame for placement of baggage atop the floor deck, rigid front and rear end walls 30, 32 standing upright from the floor deck 28 at opposing front and rear ends thereof, a roof 34 bridging between the top ends of the front and rear end walls 30, 32 in elevated overhead relation to the floor deck 28 in full-coverage relationship thereto, and curtained side walls 36 spanning respectively along opposing sides of the floor deck 28 between the front and rear end walls 30, 32. Each curtained side wall 36 frames therein a respective opening 38 through which an interior baggage space of the baggage cart, bound by the described walls and roof thereof, can be loaded an unloaded, which opening is selectively openable and closable by one or more movable curtains 40 slidably installed in the framed opening.

Both axle assemblies 12, 22 reside beneath the floor deck 28. Among the axle assemblies, the front axle assembly 12 resides nearest a front end 24A of the vehicle body 24, in this case denoted by the front end of the floor deck 28 and the associated front end wall 30 standing upright therefrom. The rear axle assembly 22 resides nearest a rear end 24B of the vehicle body 24, in this case denoted by the rear end of the floor deck 28 and the associated rear end wall 32 standing upright therefrom. The front and rear ends 24A, 24B of the vehicle body 24 are spaced apart from one another in a longitudinal direction of the baggage cart 10 denoted by a central longitudinal axis Lo running horizontally thereof at a longitudinal midplane of the baggage cart 10. Another horizontal directionality lying perpendicularly transverse to the longitudinal directionality is referred to herein as a lateral directionality. The rear axle assembly 22 is fixed to the frame 26, whereby the rotational axes of the rear ground wheels 20 are of fixed orientation, running laterally of the baggage cart 10 in perpendicularity to the longitudinal axis Lo (at least in plan view, ignoring any camber angle of those rear ground wheels 20).

In contrast, the steerable front axle assembly 12 can swivel about a vertical steering axis St that is illustrated in FIGS. 3 to 7 and vertically penetrates the overlying floor deck 28 near the front end 24A of the vehicle body 24. Rotational coupling of the steerable front axle assembly 12 to the frame 26 is made at a front cross-member of the frame 26 that spans across the underside of the floor deck 28. The rotational axes Ro of the steerable front wheels 18, while parallel and coincident to one another (at least as seen in plan view thereof, ignoring any camber angle of such wheels) will thus vary in orientation depending on the rotational position of the steerable front axle assembly 12 about the steering axis St at any given time. That said, the steerable front axle assembly 12 is shown in a straight-travel position corresponding to straight travel of the baggage cart 10 along the longitudinal axis Lo, in which the rotational axes Ro of the steerable front wheels 18 lie laterally of the baggage cart 10 in perpendicular relationship to the longitudinal axis Lo, and it is with reference to this straight-travel position of the steerable front axle assembly 12 that various positions and orientations of any componentry described herein is detailed for the easiest understanding by the reader, without overcomplication. Accordingly, any assessment of positionality, directionality and orientation necessary to construe the claimed invention should be assessed in this straight-travel state, even in scenarios where the inventive braking mechanism is likewise installed on a steerable axle assembly whose orientation may vary, though it will be appreciated that the same braking mechanism may alternatively be installed on a non-steerable fixed axle assembly.

To support both the pivotable towbar 14 and the towbar-actuated braking mechanism 16, the steerable front axle assembly 12 hosts a pair of longitudinally oriented carrier beams 42 that project longitudinally outward from beneath the front end 24A of the vehicle body 24 in parallel relationship to one another on opposite sides of, and in symmetrically spaced relationship, to the longitudinal midplane of the baggage cart 10 Near terminal front ends 42A of these carrier beams 42, the pivotable towbar 14 is rotatably journaled to the two carrier beams 42 to permit pivotal movement of the towbar 14 upwardly and downwardly about a towbar pivot axis Pt running laterally of the baggage cart 10 in perpendicular relationship to the carrier beams 42 and central longitudinal axis Lo. In the illustrated embodiment, this journaled connection of the towbar 14 is achieved by way of a hollow cylindrical cross-tube 44 affixed to a proximal end 14A of the towbar 14 in a position spanning laterally between the two carrier beams 42.

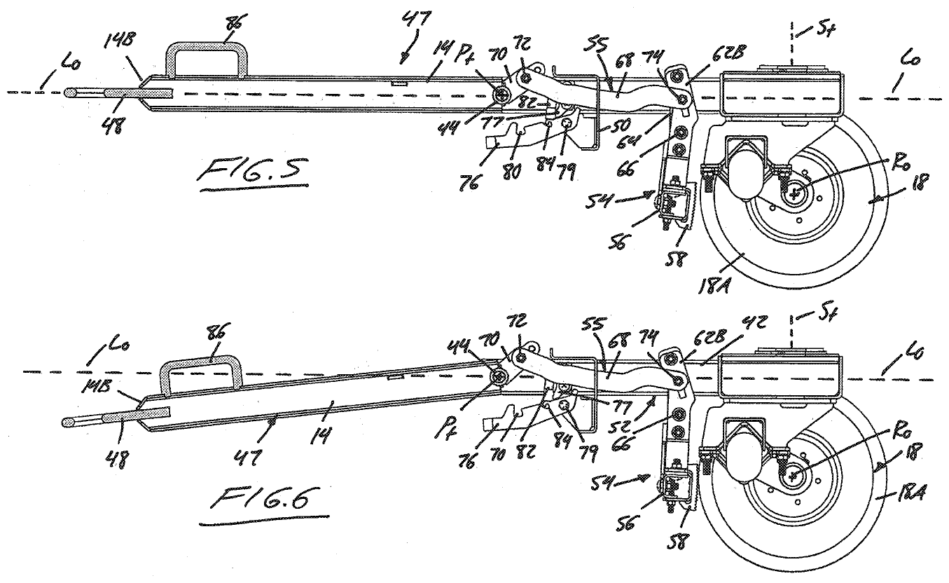

A pair of diagonal braces 46 are affixed to the cross-tube 44 and to the towbar 14 on opposing sides of the towbar in diagonally bracing relationship therebetween, in formation of a towbar assembly 47 that is composed, in this example, by at least the towbar 14, the cross-tube 44, the diagonal braces 46, and a hitch coupler 48 that is fixed to the towbar 14 at a distal end 14B thereof for the purpose of connection to the hitch of a suitable towing vehicle in any known type of hitch connection. The carrier beams 42 are rigidly interconnected by a cross-member 50 affixed thereto in a position spanning laterally therebetween near, but spaced from, the front ends 42A of the carrier beams, and behind the cross-tube 44 and the towbar pivot axis Pt embodied thereat. The cross-member 50 prevents flexing of the carrier beams 42 and maintains a consistent distance therebetween, thus also maintaining a squareness of a subframe 52 that is collectively formed by the carrier beams 42 and the cross-member 50 in a position cantilevering forwardly from the steerable front axle assembly 12 for the purpose of carrying the pivotable towbar 14 and the towbar-actuated braking mechanism 16. The cross-member 50 is omitted in FIG. 4 to afford more illustrative room in which to label componentry of the braking mechanism.

The braking mechanism 16 comprises a brake assembly 54 and a motion converter 55, by the latter of which the brake assembly 54 and the pivotal towbar 14 are movably interconnected so that pivotal motion of the towbar 14 between different positions will drive motion of the brake assembly between different positions, and more particularly between braking and non-braking positions of engaged and disengaged relationship with the tires 18A of the steerable front wheels 18 of the baggage cart 10 to impart and release a braking action thereon. The braking assembly 54 of the illustrated example employs a shared brake bar 56 that spans laterally across the underside of the subframe 52 at a spaced elevation therebeneath. The brake bar 56 has a length exceeding the distance between the two steerable front wheels 18 so as to span from a location in front of one front wheel 18 to a location in front of the other front wheel 18. At each such location in front of a respective front wheel 18, the brake bar 56 carries a respective tire brake 58 thereon that is responsible for making physical contact with the tire 18A of the front wheel 18 when the brake assembly 54 is actuated into one of its engaged states imparting the braking action to the two front wheels 18.

To carry the brake bar 56, the brake assembly 54 further comprises a pair of support arms 62A, 62B by which bar 56 is pivotally suspended from the subframe 52, for example by pivotally pinned connection of the support arms 62A, 62B to a pair of hanger brackets 64 each affixed to a respective one of the carrier beams 42. These pinned connections 66 of the support arms 62A, 62B to the hanger brackets 64 define a brake assembly pivot axis Pb running laterally of the subframe 52 a short distance in front of the two front wheels 18 at upper front quadrants thereof and a short distance beneath the two carrier beams 42 of the subframe 52. Via the support arms 62A, 62B, the brake bar 56 can thus swing, albeit by a limited angular distance, about this brake assembly pivot axis Pb, both forwardly away from the front wheels 18 in a brake release direction disengaging the tire brakes 58 from the tires 18A of the wheels 18, and rearwardly toward the front wheels 18 in a brake engagement direction to engage the tire brakes 58 with the tires 18A of the wheels 18.

The illustrated example of the braking mechanism 16 employs a single-sided drive setup where the motion converter 55 connects the pivotable towbar 14 to only one of the two pivotal support arms 62A, 62B and thus drives movement of the brake assembly 54 on only one side of the longitudinal midplane of the baggage cart 10, though it will be appreciated that other embodiments may instead duplicate a matching set of motion converter linkage components in symmetric layout across the midplane of the baggage from those which are illustrated in order to achieve a double-sided drive setup where the motion converter drives the brake assembly 54 at both of its support arms 62A, 62B. In the illustrated example, the singularly driven support arm 62B is therefore a longer support arm of greater elevational span that the other non-driven support arm 62A. Driven support arm 62B spans further upwardly its pinned connection 66 to the corresponding hanger bracket 64 than the non-driven support arm 62A. At this extended upper region of the driven support arm 62B, situated above the brake assembly pivot axis Pb, the driven support arm 62B receives pivotally pinned connection thereto of the rear end of a longitudinally oriented connection link 68 of the motion converter 55, an opposing front end of which is pivotally pinned to a crank arm 70 of the motion converter 55. This crank arm 70 is affixed to the cross-tube 44 of the towbar assembly to rotate therewith about the towbar pivot axis Pt when the towbar 14 is pivoted about that axis. This pivotal connection of the crank arm 70 to the connection link 68 is labelled as pivot point 72, and the pivotal connection of the connecting link 68 to the driven support arm 62B is labelled as pivot point 74. In the illustrated embodiment, the connecting link 68 of the motion converter 55 passes through an opening 50A in the cross-member 50 in order to make connection to the driven support arm 62B of the brake assembly 54 from the crank arm 70 of the towbar assembly.

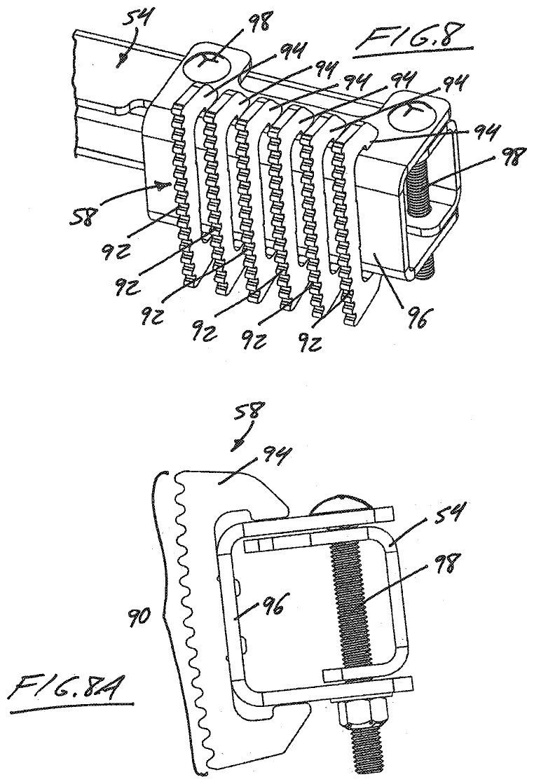

FIG. 7 illustrates the towbar assembly 47 and brake assembly 54 in a parking brake engagement state of similar purpose and effect to the towbar-actuated braking systems of the prior art, which state is once again achieved by pivotal raising of the towbar 14, while in decoupled relation thereof to a towing vehicle to which it would be otherwise connected for towing of the baggage cart 10, about its towbar pivot axis Pt into an upright position standing erect from the subframe 52 in a vertical, or near vertical, orientation, denoted here by vertical reference axis Av running lengthwise of the towbar 14 and through the towbar pivot axis Pt. In this upstanding parking position of FIG. 7, the brake assembly 54 is engaged with the front wheels 18 of the baggage cart 10, with each tire brake 58 in physical engagement with the crown of the tire 18A of the respective front wheel 18 at a location on the front circumferential half thereof. In the illustrated example, the tire brake 58 makes contact with at least at an area of the tire crown that spans between eight o'clock and ten o'clock positions around the rotational axis Ro of the wheel, as viewed in the illustrated perspective from the left side of the baggage cart. In this position, the pivot point 72 by which the towbar assembly 47 is pivotally coupled to the connecting link 68 of the motion converter 55 at a radially spaced distance from the towbar pivot axis Pt, via the crank arm 70, is situated below a horizontal reference plane containing that pivot axis Pt, which relationship is illustrated by appearance of pivot point 72 well below the longitudinal axis Lo that is drawn horizontally through the towbar pivot axis Pt and thus denotes this horizontal reference plane. As viewed from the left of the baggage cart 10, the pivot point 72 resides between a four o'clock and six o'clock position around the towbar pivot axis Pt, closer to five o'clock than either four or six o'clock in the illustrated instance, and more particularly between four o'clock and five o'clock in this illustrated instance.

To hold the raised towbar 14 in this upstanding parking position of FIG. 7, a spring loaded securement latch 76 is pivotally supported on the same carrier beam 42 whose respective hanger bracket 64 pivotally carries the driven support arm 62B of the brake assembly 54. This carrier beam 42 is also neighboured on the inner side thereof by the connecting link 68 that is pinned to the crank arm 70 of the towbar assembly 47. In the illustrated example, the securement latch 76 is indirectly support on the carrier beam 42 via pinned connection of the securement latch to a mounting lug 77 on the carrier beam 42, which mounting lug 77 doubles as a physical stop setting a default spring-biased position of the securement latch 76. The crank arm 70 carries a latching pin 78 thereon that projects laterally therefrom on the outer side thereof opposite the connecting link 68, and the securement latch 76 has a pin slot 80 therein for engagement thereof by the latching pin 78 in the upstanding parking position of the towbar assembly 47. A catch part of the securement latch 76 in which the pin slot 80 is defined is spring biased upwardly about the lug-carried pivot point 79 of the securement latch by a tension spring 82. The tension spring 82 has one end anchored to the carrier beam 42 of the subframe 52, for example via hooked connection to the lug 77, and the other end anchored to the securement latch 76 at a spring hook 84 thereof (though such hooked connection of the spring 82 to the latch 76 is omitted in the drawings, where the spring is shown in a fully collapsed state, owing to CAD modeling limitations, and is thus not shown stretched between its two connection points).

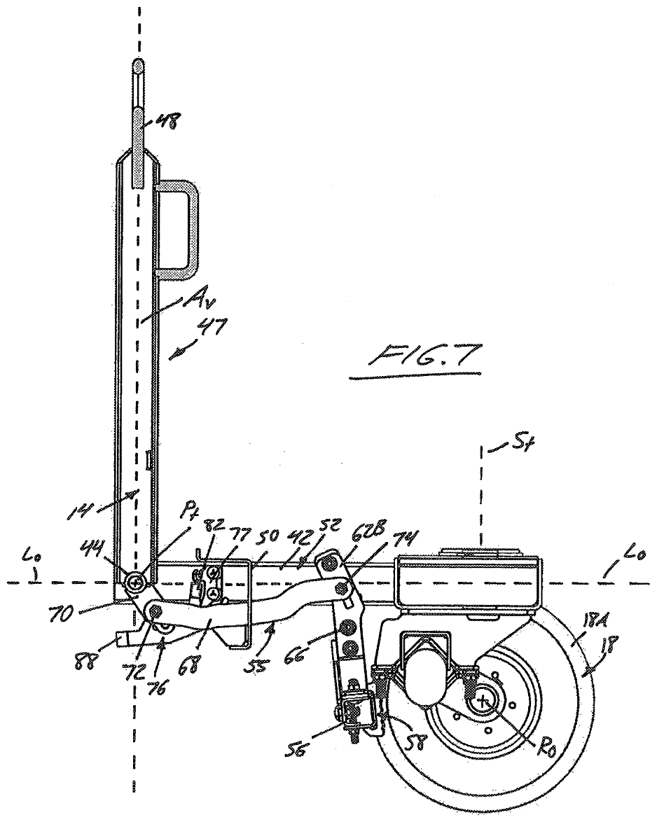

FIG. 5 shows the towbar 14 lowered from its upstanding parking position to a towing position of less upright and more horizontal orientation, which more accurately is a truly horizontal orientation in the illustrated instance, where the towbar lies inline with the horizontally drawn longitudinal axis Lo. In this towing position, instead of standing fully or substantially upright from the subframe 52 like the parking position, the towbar spans forwardly from the front end of the subframe 52 from between the front ends 42A of the carrier beams 42 thereof, denoting a useful working position of the towbar in which it would be connected to a towing vehicle for towed transport of the baggage cart 10. It will be appreciated that in practice, the towing position may vary somewhat from the truly horizontal orientation illustrated in FIG. 5 depending on the relative height of the subframe 52 of the baggage cart 10 and the hitch of the towing vehicle by which the baggage cart will be towed. Regardless, in this towing position, the brake assembly 54 is completely disengaged from the front wheels 18 of the baggage cart 10, with the tire brakes 58 offset forwardly from the tires 18A in spaced relation therefrom, allowing rotation of the tires 18A and rolling transport of the baggage cart 10 under towage thereof by the towing vehicle. In such state, reliance is made on the connection between the towing vehicle and the baggage cart 10 to hold the baggage cart stationary when the towing vehicle is stopped, without reliance on the baggage cart's braking mechanism 16. In this position, the pivot point 72 by which the towbar 14 is pivotally coupled to the connecting link 68 of the motion converter 55 via the crank arm 70 is now instead situated above the aforementioned horizontal reference plane, denoted by longitudinal axis Lo drawn horizontally through the towbar pivot axis Pt, as a result of having been arcuately shifted ninety degrees counterclockwise around the towbar pivot axis Pt from the position described above with regard to FIG. 7.

After decoupling of the towbar 14 from the towing vehicle, manual lifting of the towbar from the generally horizontal towing position of FIG. 5 to the upstanding parking position of FIG. 7 is performed by the user, for example using the illustrated lift handle 86 near the coupler-equipped distal end 14B of the towbar 14. Such lifting of the towbar moves the pivot point 72 arcuately downward about the towbar pivot axis Pt, thus initially driving the front end of the connecting link 68 rearward and downward. However, upon passage of the pivot point 72 downwardly through a three o'clock position coincident with the horizontal reference plane (illustrated by longitudinal axis Lo), continued lifting of the towbar 14 toward the upstanding parking position then acts to move the pivot point 72 arcuately forwardly, thus pulling forwardly on the connecting link 68. This in turn pulls forwardly on the driven support arm 62B of the brake assembly 54 at the pivot point 74, which being situated above the pinned connection 66 of the driven support arm 62B to the hanger bracket 64 causes the brake bar 56 at the bottom of the driven support arm 62B to swing rearwardly, thereby driving the tire brakes 58 into engagement with the tires 18A of the two front wheels 18.

At the same time, the latching pin 78 carried on the same crank arm 70 as the pivot point 72 is moved on an equivalent arcuate path into contact with the top edge of the spring loaded securement latch 76, and then in sliding engagement rearwardly therealong and ultimately into the pin slot 80, in synchronicity to the towbar 14 reaching the upstanding parking position. Here, the spring-loaded character of the securement latch 76 holds the towbar 14 in this upstanding parking position, until such time as a user releases the latched state of the latching pin 78, typically by foot-driven depression of the securement latch 76 form its spring bias position, for example at a foot peg 88 extending laterally outward from the securement latch 76 at a rear end thereof. Such foot peg may be an integrally bent portion of the securement latch 76 itself, or a separate component affixed thereto. Such foot driven depression of the securement latch 76 disengages the latching pin 78 form the pin slot 80, thus freeing the towbar 14 into a pivotable state so that the user can pull the towbar 14 downwardly from its upright parking position to the towing position in order to perform coupling of the towbar 14 to the towing vehicle.

During this lowering movement of the towbar 14 from its upstanding parking position, the pivot point 72 is initially moved arcuately rearward, pushing the connecting link 68 rearward, which in turn pushes the upper region of the driven support arm 62B rearward at pivot point 74, which in turn swings the brake bar 56 forwardly away from the front wheels 18, thus withdrawing the tire brakes 58 out of engagement with the tires 18A to release the parking brake action. As can be seen in FIG. 5, the pivot point 72 may move upwardly past a three o'clock position relative to the towbar pivot axis Pt as the towbar ultimately approaches the towing position, thus imparting some forward movement of pivot point 72 during this last stage of travel, but not enough forward movement to re-engage the tire brakes 58 with the front wheels 18, instead leaving the front wheels unbraked.

FIG. 6 shows the towbar 14 in a dropped position of forwardly declined orientation from its towing position of FIG. 5, for example owing to a failed hitch connection during towed conveyance of the baggage cart 10, or owing to user-dropping of the towbar 14 during or after decoupling of the towbar from a towing vehicle. In such droppage of the towbar's distal end 14B from the towing position, the crank arm 70 on the opposing proximal side of the towbar axis Pt swings upward and forward about the towbar axis Pt, thereby pulling forwardly on the connecting link 68, and thus once again swinging the brake bar 56 rearwardly, and thereby driving the tire brakes 58 thereon likewise rearwardly into engagement with the tires 18A of the front wheels 18 of the baggage cart 10, thus imparting a failsafe braking action on the baggage cart to cease or prevent runaway movement thereof given the potentially accidental droppage of the towbar 14. In subsequent manual lifting of the towbar 14 from its dropped position back up to the towing position, the pivot point 72 is moved arcuately rearward and downward, pushing the connecting link 68 rearward, which in turn pushes the upper region of the driven support arm 62B rearward at pivot point 74, which in turn swings the brake bar 56 forwardly away from the front wheels 18, thus withdrawing the tire brakes 58 out of engagement with the tires 18A to release the failsafe braking action and once again permit rolling of the front wheels 18 under towed conveyance of the baggage cart 10.

The pivot point never moves outside a twelve o'clock to six o'clock range around the towbar pivot axis Pt, a seen from the left size perspective where twelve and six o'clock reside on the vertical reference axis Av of FIG. 7 and denote locations of maximum and minimum elevation to the horizontal reference plane denoted by longitudinal axis Lo, and the three o'clock position denotes a location between the vertical reference plane Av and another vertical reference plane containing the rotational axes Ro of the front wheels 18, visually denoted by steering axis St in the illustrated example. In other words, the pivot point 72 remains within the two rear quadrants of a polar coordinate system centered on the towbar pivot axis Pt throughout a full range of towbar and braking system movement.

In summary, the motion converter linkage composed of the crank arm 70, the support arms 62B and the connecting link 68 connected therebetween, thus uniquely achieves a towbar-actuated braking mechanism 16 that not only applies a self-maintained parking brake action in a latched upright parking position of the towbar, but also imparts a failsafe braking action in the event of gravitational droppage of the towbar from its towing position, in a notably novel and advantageous improvement over the known prior art. The motion converter linkage releases such braking actions upon manual return of the towbar 14 to the towing position from either of the two brake-engaging towbar positions.

The present application also discloses a novel design approach to the tire brakes 58, which are typically identical to one another, and one of which is shown in closeup isolation in FIG. 8. Instead of engaging the tire with a flat bar, pad or right angle member, each tire brake 58 of the present invention instead possesses an undulating shape profile 90 of alternating peaks and valleys along a tire-facing side of the tire brake 58, preferably of a scalloped character with rounded peaks and valleys of curved convexity and concavity respectively, as opposing to a more jagged serration pattern, which may bite to aggressively into the tire, to the detriment thereof.

In the illustrated implementation, rather than a singular and broad braking face of undulating shape profile in one of the face's two dimensions, and full width continuity in the other, the illustrated embodiment instead presents a plurality of discretely spaced undulation strips 92 that are spaced apart from one another across a width of the tire-facing side of the tire brake 58. More specifically, the illustrated embodiment adopts a multi-piece construction for the tire brake 58, being composed of a plurality of separate plates 94, each configured with the undulating pattern at a perimeter edge of the plate. As shown, the plates 94 may be identical in shape, and aligned with one another, so that the valleys in the undulating edge of one plate align with valleys in the undulating edge of each of its neighbouring plates, though in other embodiments, the peaks and valleys need not necessarily be aligned in such fashion, and may employ plates of varying undulation pattern, or matching plates among which neighbouring plates are positioned in staggered offset to one another. In the illustrated embodiment, the plates are mounted to a common holder 96, embodied in a sleeve or channel that is fittable over and end region of the brake bar 56, and removably fastened thereto by bolts 98 to enable convenient removal and replacement of either tire brake, if needed. That said, in other embodiments the tire brakes could be affixed directly to the brake bar 56.

In the illustrated implementation, the undulating pattern of alternating peaks and valleys is one that appears in vertical planes of normal (orthogonal) relationship to the rotational axis Ro of the wheel, as opposed to planes parallel to the rotational axis Ro. The result is that the undulating shape profile, intended to provide superior frictional hold to the tire rubber versus prior tire brake geometries known to the applicant, resides generally tangential to the tire, as opposed to running axially across the width of the tire, and the plates embodying the strips of undulating pattern are spaced apart from one another in the width direction of the tire. In this implementation, the rolling direction of the tire is thus one that runs along the undulating pattern. Other embodiments may instead feature reorientation of the tire brake 58 to have the undulating shape profile run cross-wise to the tire tread, rather than tangentially along the circumference of the tire, in which case the plates would be spaced apart in a circumferential or tangential directionality of the tire.

Since various modifications can be made in the invention as herein above described, and many apparently widely different embodiments of same made, it is intended that all matter contained in the accompanying specification shall be interpreted as illustrative only and not in a limiting sense.

1. A towable vehicle having a towbar-actuated braking mechanism, said towable implement comprising:
a vehicle body for carriage of a load thereon and having front and rear ends of opposing relationship to one another in a longitudinal direction;
a plurality ground wheels by which the vehicle body is supported for rolling movement thereof over the ground, and among which there is included at least one braked ground wheel on which a braking action is impartible to inhibit rolling movement of the towable vehicle;
a towbar coupled to the vehicle body and usable for towing thereof when coupled to a separate towing vehicle, said towbar being pivotally supported for upward and downward movement of a distal end of said towbar about a towbar pivot axis that is situated nearer to an opposing proximal end of said towbar than to said distal end, said towbar being pivotable about said pivot axis between a parking position, a towing position and a dropped position, among which the parking position has a most upright orientation placing the distal end at an elevation above the towbar pivot axis, the dropped position has a most declined orientation placing the distal end at a lower elevation nearer to ground than in the parking and towing positions, and the towing position resides intermediately of the parking and dropped positions and has a most horizontal orientation with the distal end at an intermediate elevation between those occupied in the parking and dropped positions;
a brake assembly residing proximate the at least on braked and movable relative thereto between braking and non-braking positions of engaged and disengaged relation to said at least one braked ground wheel; and
a motion converter connected between said towbar and said brake assembly to drive motion of the brake assembly in responsive relation to pivotal movement of the towbar about the towbar pivot axis, and specifically configured to drive motion of the brake assembly into said engaged relation with said at least one ground wheel both in movement of the towbar from the towing position to the parking position and in movement of the towbar from the towing position to the dropped position, whereby the at least one braked ground wheel is engaged by the brake assembly in both the parking and dropped positions of the towbar to thereby impart both a parking brake function in the parking position and a failsafe braking function in the dropped position.

2. The towable vehicle of claim 1 wherein the brake assembly resides in front of said at least one braked ground wheel.

3. The towable vehicle of claim 1 wherein said brake assembly is supported for pivotal movement thereof about a brake assembly pivot axis that lies parallel to the towbar pivot axis.

4. The towable vehicle of claim 3 wherein said motion converter is coupled to the brake assembly at a location of greater elevation than the brake assembly pivot axis.

5. The towable vehicle of claim 3 wherein said brake assembly pivot axis lies parallel, at least in plan view, to a rotational axis of the at least one braked ground wheel.

6. The towable vehicle of claim 5 wherein the brake assembly pivot axis resides at greater elevation than said rotational axis of said at least one braked ground wheel.

7. The towable vehicle of claim 3 wherein the brake assembly pivot axis resides at greater elevation than rotational axis of said at least one braked ground wheel.

8. The towable vehicle of claim 1 wherein, referring to a horizontal reference plane containing the towbar pivot axis, a pivot point at which the towbar and the motion converter are pivotally coupled together at a radial distance from the towbar pivot axis resides above said reference plane in the dropped position of the towbar and below said reference plane in the parking position of the towbar, and sweeps through said horizontal reference plane in movement of the towbar between said parking and dropped positions.

9. The towable vehicle of claim 8 wherein said pivot point also resides above said horizontal reference plane in the towing position.

10. The towable vehicle of claim 8 wherein, referring to twelve o'clock and six o'clock positions relative to the towbar pivot axis in a vertical reference plane normal to, and centered on, the towbar pivot axis as points of greatest and least elevation above and below the horizontal reference plane, and a three o'clock position as one residing in the horizontal reference plane at a location between vertical planes containing the towbar and brake assembly pivot axes, said pivot point remains between said twelve o'clock and six o'clock positions throughout a full range of movement between the parking and dropped positions of the towbar.

11. The towable vehicle of claim 1 wherein the brake assembly comprises, for each braked ground wheel, a respective tire brake for engaged contact with a tire of said braked ground wheel, said respective tire brake comprising an undulating shape profile at a tire-facing side thereof.

12. The towable vehicle of claim 11 wherein each tire brake comprises a plurality undulated strips of spaced apart relationship to one another.

13. The towable vehicle of claim 12 wherein said undulated strips are spaced apart from one another in a width direction of the tire.

14. The towable vehicle of claim 12 wherein said undulated strips are embodied in perimeter edges of a respectively plurality of spaced apart plates.

15. The towable vehicle of claim 11 wherein said undulating shape profile is embodied in planes lying normal to an axial direction of the tire.

16. A towable vehicle with a towbar-actuated braking mechanism, said towable implement comprising:
a vehicle body for carriage of a load thereon and having front and rear ends of opposing relationship to one another in a longitudinal direction;
a plurality ground wheels by which the vehicle body is supported for rolling movement thereof over the ground, and among which there is included at least one braked ground wheel on which a braking action is impartible to inhibit rolling movement of the towable vehicle;
a towbar coupled to the vehicle body and usable for towing thereof when coupled to a separate towing vehicle, said towbar being pivotally supported for upward and downward movement of a distal end of said towbar about a towbar pivot axis that is situated nearer to a proximal end of said towbar than to said distal end, said towbar being pivotable about said pivot axis between at least a parking position and a towing position, among which the parking position has a more upright orientation placing the distal end at an elevation above the towbar pivot axis, and the towing position spans further forwardly from the pivot axis than said parking position;
a brake assembly residing proximate the at least one braked ground wheel and movable relative thereto braking and non-braking positions of engaged and disengaged relation to said at least one braked ground wheel; and
a motion converter connected between said towbar and said brake assembly to drive motion of the brake assembly in responsive relation to pivotal movement of the towbar about the towbar pivot axis, and specifically configured to drive motion of the brake assembly into said engaged relation with said at least one braked ground wheel in movement of the towbar from the towing position to the parking position so as to thereby engage the at least one braked ground wheel and impart a parking brake function thereto in the parking position,
wherein the brake assembly comprises, for each braked ground wheel, a respective tire brake for engaged contact with a tire of said braked ground wheel, said respective tire brake comprising an undulating shape profile at a tire-facing side thereof.

17. The towable vehicle of claim 16 wherein each tire brake comprises a plurality undulated strips of spaced apart relationship to one another.

18. The towable vehicle of claim 17 wherein said undulated strips are spaced apart from one another in a width direction of the tire.

19. The towable vehicle of claim 17 wherein said undulated strips are embodied in edges of a respectively plurality of spaced apart plates.

20. The towable vehicle of claim 16 wherein said undulating shape profile is embodied in planes lying normal to an axial direction of the tire.

21. A tire brake for use in a towbar-actuated braking mechanism, said tire brake comprising an undulating shape profile at a tire-facing side thereof.
